(19) United States
(12) Patent Application Publication
(10) Pub. No.: US 2021/0400942 A1
(43) Pub. Date: Dec. 30, 2021

(54) Equine Shoe Metal/Polymer Assembly

(71) Applicant: Monty L. Ruetenik, Clear Lake Shores, TX (US)

(72) Inventor: Monty L. Ruetenik, Clear Lake Shores, TX (US)

(21) Appl. No.: 16/915,267

(22) Filed: Jun. 29, 2020

(51) Int. Cl. A01L 5/00; A01L 15/00

(52) U.S. Cl. CPC A01L 5/00; A01L 15/00

(57) ABSTRACT

An equine shoe assembly, comprising a dual density polymer shoe having a relatively soft bottom patterned section and a base section of harder polymer capable of holding nails and maintaining the shoe is relatively rigid and structurally intact during use on equine hooves fitted in a conventional metal equine shoe supporting the harder polymer base section.

### BACKGROUND

### Field of Invention

An equine shoe assembly, comprising a dual density polymer shoe having a relatively soft bottom patterned section and a base section of harder polymer capable of holding nails and maintaining the shoe is relatively rigid and structurally intact during use on equine hooves fitted in a conventional metal equine shoe supporting the harder polymer base section.

### Background

U.S. Pat. No. 10,548,304 issued Feb. 4, 2020 describes a number of polymer dual equine shoes having a relatively soft bottom patterned section and a base section of harder polymer capable of holding nails and maintaining the shoe is relatively rigid and structurally intact during use on equine hooves. For some applications and with some users it is desirable that the base section be supported by a metal equine shoe that provides greater rigidity and structural integrity. The present invention is, therefore such an assembly, comprising a dual density polymer shoe as described in U.S. Pat. No. 10,548,304 fitted in a conventional metal equine shoe. The disclosure and drawing of U.S. Pat. No. 10,548,304 are incorporated herein by reference for all purposes.

### BRIEF DESCRIPTION OF THE DRAWINGS

FIG. 1A is a top view of an exemplary embodiment of a shoe of U.S. Pat. No. 10,548,304 included herein for reference only.

FIG. 1B is a bottom view of an exemplary embodiment of a shoe of U.S. Pat. No. 10,548,304 included herein for reference only.

FIG. 1C is an end view of an exemplary embodiment of a shoe of U.S. Pat. No. 10,548,304 included herein for reference only.

FIG. 1D is an opposite end view of an exemplary embodiment of a shoe of U.S. Pat. No. 10,548,304 included herein for reference only.

FIG. 1E is a side view of an exemplary embodiment of a shoe of U.S. Pat. No. 10,548,304 included herein for reference only.

FIG. 1F is a perspective view of an exemplary embodiment of a shoe of U.S. Pat. No. 10,548,304 included herein for reference only.

FIG. 2A is an exploded view of assembly of an embodiment of the invention showing how a two component assembly of a modified exemplary polymer shoe of U.S. Ser. No. 10/548,304 (FIGS. 1-4) is fitted to a metal equine shoe.

FIG. 2B is a top view of the completed assembly of FIG. 2A.

FIG. 2C is a side view of the completed assembly of FIG. 2A.

FIG. 2E is an end view of the completed assembly of FIG. 2A1.

FIG. 2F is a perspective view of the completed assembly of FIG. 2A.

### DETAILED DESCRIPTION

The present invention is an assembly of polymers shoes described in U.S. Pat. No. 10,548,304 (incorporated herein by reference for all purposes) with a metal equine shoe. This assembly provides the superior “breakover” qualities of the polymer shoes of the patent and the rigidity and attachment ability of a conventional metal equine shoe. Any of the polymer shoes described in U.S. Pat. No. 10,548,304 are suitable for this assembly as are any of the conventional equine open center shoes. The metal shoes may be any metal, such as iron, steel, aluminum and other more exotic metals.

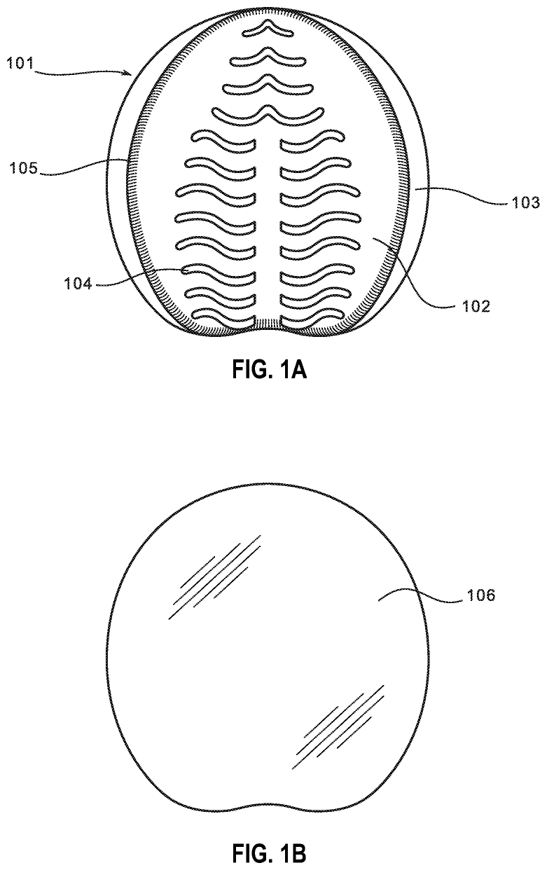

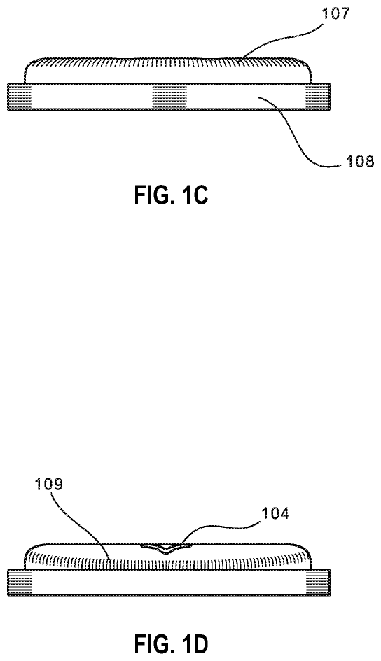

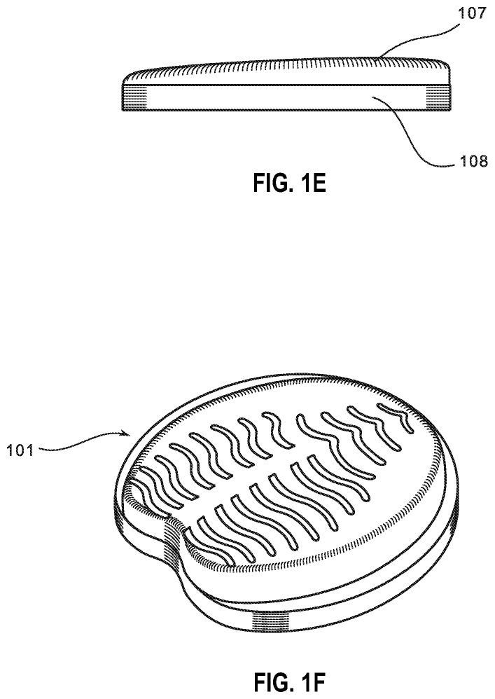

In embodiment of this invention the polymer shoes as described in U.S. Pat. No. 10,548,304 are adapted so the softer bottom section (102 in FIG. 1A-1F) fits into the open space of the metal equine shoe and the harder base of the polymer modified to fit under the rim of a metal equine shoe and coextensive with its outer circumference.

Referring to the reference drawings of an embodiment, from U.S. Pat. No. 10,548,304, the shoe 102, has a soft patterned section, 102, and a harder base support section, 103. The patterns, 104, of this embodiment are shown as is the edge, 105, where the soft section 102 connects to the base section 103.

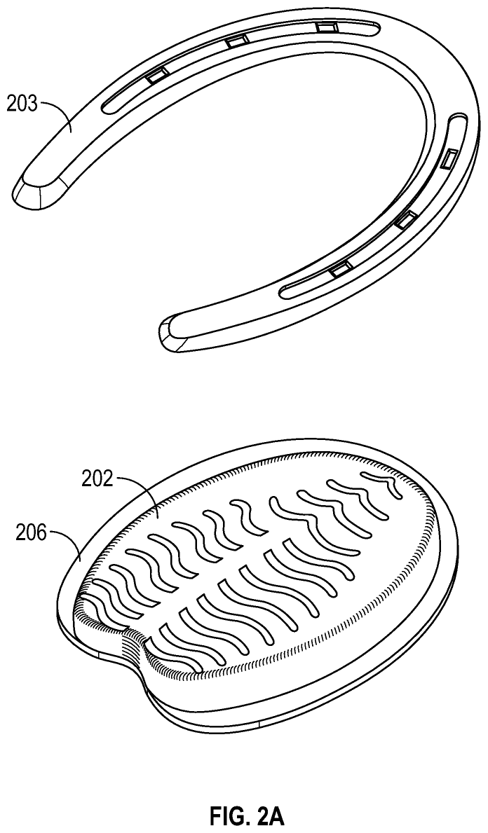

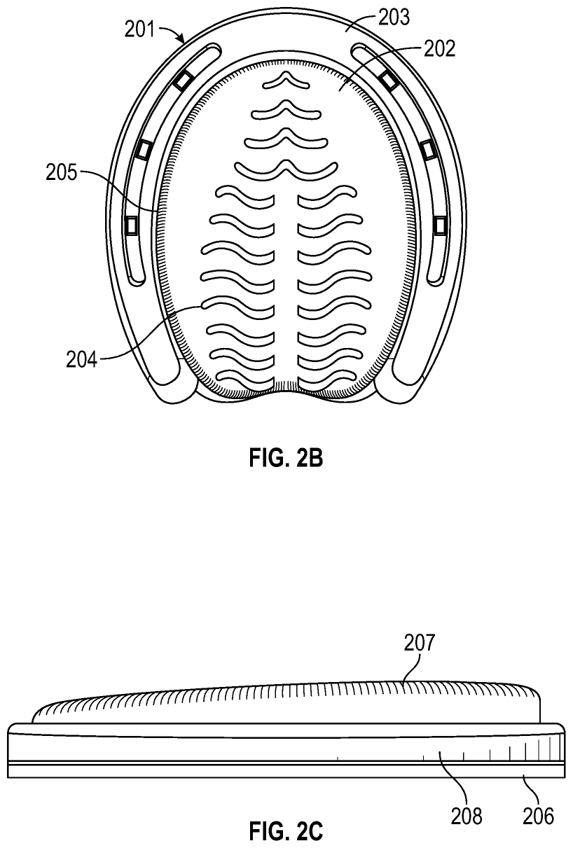

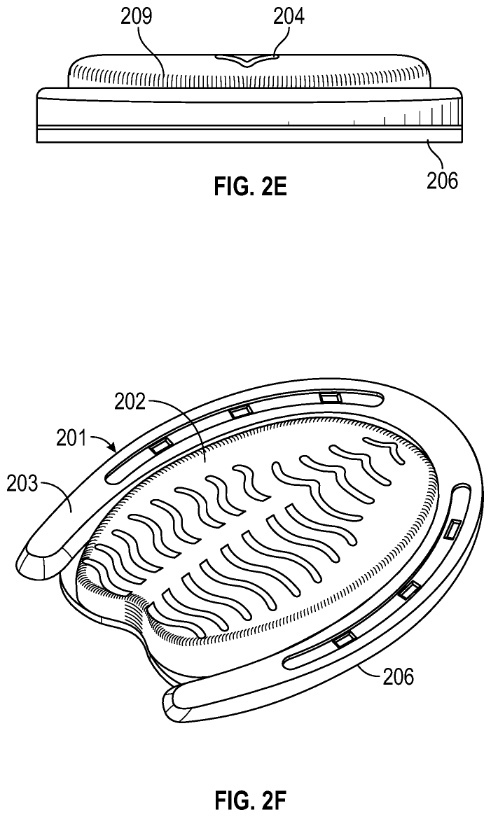

Also referring to the drawings, FIG. 2A is an exploded view of the assembly of an embodiment of the invention. The metal shoe 203 fits over the base rim 206 of the dual density polymer shoe and the softer raised section 202 projects through the opening in the metal shoe to form the assembly, 201, shown in FIG. 2B-2E. This provided a metal rigid support for the polymer shoe that can be securely attached to the underside of an equine hook but retains the softer “breakover” structure of the softer polymer section 202.

The polymer shoe as described and claimed in U.S. Pat. No. 10,548,304 is “A shoe for an equine comprising a solid member that covers substantially the entire underside of a hoof, wherein the solid member has at least two strata, and wherein:
(a) the at least two strata comprise an uppermost stratum of material of at least Shore A ninety (90) and a lowermost stratum of Shore A hardness of about forty-five to sixty-five (45-65);
(b) the bottom surface of the solid member comprises a convex surface;
(c) the convex surface and uppermost stratum are configured such that an equine hoof stepping down on the uppermost stratum causes at least a generally center portion of the uppermost stratum to flex upwards toward an underside of the equine hoof.” Thus, the assembly of the present invention is the structure defined above wherein the uppermost strata is adapted to be supported on the rim of a conventional metal equine shoe and the lowermost strata adapted to fit in the center opening of the conventional metal shoe. The uppermost strata may be somewhat softer in an embodiment of this invention because the metal shoe will provide support. Thus, the uppermost section may be, in some embodiments at least about 80 Shore A. Since it is customary that metal shoes be somewhat shaped by the applicator to fit the equine hoof to which they are to be attached, as by curving the toe upward, the softer uppermost polymer section bill allow the polymer to be more easily conformed to the metal shoe shape. In some embodiments, the uppermost section of the polymer shoe may be attached to the metal shoe by adhesive.

The polymer shoe will have the other attributes as described and claimed in claims 11-19 of U.S. Pat. No. 10,548,304 (incorporated herein by reference for all purposes). Such attributes include the embodiments shown if FIGS. 2A-2F, 3A-33C, 4A-4B, 6, 7, 8 and 9 and their respective descriptions in the specification, all of which is incorporated herein by reference.

### Methods

The invention is also a methods of use of the equine shoe assembly. The methods is the same as that described and claimed for the equine shoes of U.S. Pat. No. 10,548,304 (incorporated herein by reference). Thus, broadly, an embodiment of the method is the assembly structure described above in the method “of therapy of an equine hoof comprising:
(1) after an insult to the hoof, providing an equine boot and elastomeric orthotic pad, wherein:
(i) the boot comprises: (a) an upper section made from flexible material, shaped to fit around the hoof and of a height to reach above the hoof, having fastening means to fasten a front and a rear of the upper section together around a leg of an equine, and (b) a bottom section, comprising an elastomer sole plate attached to the upper section and having a wall around a circumference of the sole plate,
(ii) the elastomeric orthotic pad is disposed in the bottom of the boot, and
(iii) the wall of the sole plate is of sufficient height and strength to constrain deformation of the elastomeric orthotic pad placed therein, and which is compressed by the weight of a horse's hoof;
(2) once the acute or serious injury is abated, replacing the equine boot with an equine shoe assembly;
wherein:
the equine shoe assembly comprises a solid member that covers substantially the entire underside of a hoof, wherein the solid member has at least two strata, and wherein:
(i) the at least two strata comprise an uppermost stratum of material of at least Shore A ninety (90) and a lowermost stratum of Shore A hardness of about forty-five to sixty-five (45-65); (ii) the bottom surface of the solid member comprises a convex surface;
(iii) the convex surface and uppermost stratum are configured such that an equine hoof stepping down on the uppermost stratum causes at least a center portion of the uppermost stratum to flex upwards toward an underside of the equine hoof; wherein, the uppermost strata is adapted to be and is supported on the bottom rim of a conventional metal equine shoe having a top and bottom rim and a center opening and the lowermost strata adapted to fit in and fitted in the center opening of the conventional metal shoe.

Further limitations of the method described and claimed in U.S. Pat. No. 10,548,304 are applicable to the present assembly.

In the foregoing specification, the invention has been described with reference to specific embodiments thereof. It will, however be evident that various modifications and changes can be made thereto without departing from the broader spirit and scope of the invention as set forth in the appended claims. The specification and drawings are, accordingly, to be regarded in an illustrative rather than a restrictive sense. Therefore, the scope of the invention should be limited only by the appended claims.

1. An equine shoe assembly comprising a solid member that covers substantially the entire underside of a hoof, wherein the solid member has at least two strata, and wherein:
(a) the at least two strata comprise an uppermost stratum of material of at least Shore A ninety (80) and a lowermost stratum of Shore A hardness of about forty-five to sixty-five (45-65);
(b) the bottom surface of the solid member comprises a convex surface;
(c) the convex surface and uppermost stratum are configured such that an equine hoof stepping down on the uppermost stratum causes at least a generally center portion of the uppermost stratum to flex upwards toward an underside of the equine hoof;
wherein, the uppermost strata is adapted to be and is supported on the bottom rim of a conventional metal equine shoe having a top and bottom rim and a center opening and the lowermost strata adapted to fit in and fitted into the center opening of the conventional metal shoe.

2. The equine shoe assembly of claim 1 wherein the uppermost stratum of material of at least Shore A ninety (90).

3. The shoe of 1 wherein:
(i) the convex surface comprises a landing area which is, when viewed from underneath the shoe, bounded on a left and right side by two compound curves, a left curve and a right curve, running generally from the heel to the toe;
(ii) the compound curves, in relation to a centerline running from the heel to the toe of the shoe, each comprise: (a) a concave curve, curving towards the centerline, nearer the toe and, (b) a convex curve, curving away from the centerline, nearer the heel;
(iii) the landing area so bounded is gently convex from left to right, allowing the shoe to rock side to side no more than five (5) degrees from horizontal when the shoe is substantially horizontal to a ground plane;
(iv) a center of the concave curve of the right curve and left curve is located approximately at sixty (60) degrees and three hundred (300) degrees from the centerline, respectively, measuring clockwise starting at the toe;
(v) the convex surface is three-eighths (⅜) to three-quarters (¾) of an inch thick; and
(vi) a minimum width between the compound curves occurs further towards the toe than a maximum width between them, the minimum width being sixty (60) to seventy (70) percent shorter than the maximum width.

4. The shoe of 1 wherein:
(i) the convex surface comprises a convex curve when viewed from a side of the shoe, curved out away from the top surface of the shoe, running from the toe to the heel of the shoe;
(ii) the convex surface is three-eighths (⅜) to one (1) inch thick at a maximum thickness, the maximum thickness occurring at least at a peak line running from side to side across the shoe, the peak line positioned back from the toe of the shoe between forty (40) to sixty (60) percent of a total length of the shoe;
(iii) the slope of the convex curve, accelerating towards the top surface of the shoe in both directions at increasing distance from the peak line towards the toe and heel of the shoe;
(iv) the convex surface comprises a fore landing area bounded towards the heel by the peak line and towards the toe by a line running from side to side across the shoe and positioned back from the toe of the shoe between twelve (12) and twenty-five (25) percent of the total length of the shoe;
(v) the convex surface comprises a rear landing area bounded: (a) towards the toe by a line running from side to side and positioned forward from the heel of the shoe between fifty (50) to seventy (70) percent of the total length of the shoe, and (b) towards the heel by a line running from side to side across the shoe and positioned forward from the heel of the shoe between five (5) and twenty-five (25) percent of the total length of the shoe;
(vi) rearward of the rear landing area, the convex surface curves upward towards the top surface of the shoe;
(vii) the convex surface comprises a rocker toe area forward of the fore landing area, the convex curve configured such that the shoe can roll forward while maintaining contact of the convex surface with a relatively flat ground surface such that the top surface is at angle of at least twenty (20) degrees relative to the ground surface before the uppermost stratum touches the ground surface; and
(viii) left and right sides of the fore landing area, the rear landing area, and the rocker toe area are radiused.

5. The shoe of 1 wherein:
(i) the convex surface comprises a first convex curve when viewed from a side of the shoe, curved out away from the top surface of the shoe, and running from the toe to the heel of the shoe;
(ii) the convex surface comprises a second convex curve when viewed end-on from the toe or heel of the shoe, curved out away from the top surface of the shoe, and running from side to side across the shoe;
(iii) the convex surface is one-eighth (⅛) to one-half (½) inch thick at a maximum thickness, the maximum thickness occurring at least along a peak line running from side to side across the shoe, the peak line positioned forward from the heel of the shoe between twenty-five (25) to fifty (50) percent of a total length of the shoe;
(iv) rearward of the rear landing area, the convex surface curves upward towards the top surface of the shoe; and
(v) the convex surface comprises a rocker toe area forward of the peak line area, the first convex curve configured such that the shoe can roll forward while maintaining contact of the convex surface with a relatively flat ground surface such that the top surface is at an angle of at least ten (10) degrees relative to the ground surface before the uppermost stratum touches the ground surface.

6. The shoe of 5 further wherein:
(vii) a plurality of bosses extend outward from the convex surface of the shoe, in directions approximately normal to the convex surface at a location of a particular boss;
(viii) the bosses are of a height between one-eighth (⅛) to one-quarter (¼) of an inch;
(xi) the height of the bosses permits the shoe to pivot forward on the foremost bosses, past the rocker toe area, at an angle of at least fifteen (15) degrees relative to the ground surface before the uppermost strata touches the ground surface; and
(x) the height of the bosses allows the shoe to pivot side-to-side on the outermost bosses, at an angle of at least fifteen (15) degrees relative to the ground surface before the uppermost strata touches the ground surface.

7. The shoe of 1 wherein the uppermost strata extends leftward and rightward past the convex surface, creating a lip.

8. The shoe of 1, wherein a bottom surface of the solid member is patterned.

9. The shoe of 8 wherein the pattern comprises generally wave-shaped grooves oriented generally side-to-side across the convex surface of the shoe.

9. The shoe of 8 wherein the pattern comprises both (a) grooves oriented generally side-to-side across the convex surface of the shoe, and (b) elliptical bosses configured such that the tops of the bosses form a part of the convex surface.

10. The equine shoe of 1, further comprising a foam insert between the shoe and the hoof, wherein:
(i) the foam insert is made from a plurality of components;
(ii) the components are provided in containers of predetermined quantity;
(iii) the components are not all mixed together until the foam is needed, at which time at least two of the components are mixed together to result in an uncured foam mixture; and
(iv) the uncured foam mixture cures, resulting in the foam insert, while constrained at least by the hoof and the shoe.

11. A method of therapy of an equine hoof comprising:
(1) after an insult to the hoof, providing an equine boot and elastomeric orthotic pad, wherein:
(i) the boot comprises: (a) an upper section made from flexible material, shaped to fit around the hoof and of a height to reach above the hoof, having fastening means to fasten a front and a rear of the upper section together around a leg of an equine, and (b) a bottom section, comprising an elastomer sole plate attached to the upper section and having a wall around a circumference of the sole plate,
(ii) the elastomeric orthotic pad is disposed in the bottom of the boot, and
(iii) the wall of the sole plate is of sufficient height and strength to constrain deformation of the elastomeric orthotic pad placed therein, and which is compressed by the weight of a horse's hoof;
(2) once the acute or serious injury is abated, replacing the equine boot with an equine shoe;
wherein:
the equine shoe comprises a solid member that covers substantially the entire underside of a hoof, wherein the solid member has at least two strata, and wherein:
(i) the at least two strata comprise an uppermost stratum of material of at least Shore A eighty (80) and a lowermost stratum of Shore A hardness of about forty-five to sixty-five (45-65);
(ii) the bottom surface of the solid member comprises a convex surface;
(iii) the convex surface and uppermost stratum are configured such that an equine hoof stepping down on the uppermost stratum causes at least a center portion of the uppermost stratum to flex upwards toward an underside of the equine hoof, and
wherein, the uppermost strata is adapted to be and is supported on the bottom rim of a conventional metal equine shoe having a top and bottom rim and a center opening and the lowermost strata adapted to fit in and fitted into the center opening of the conventional metal shoe.

12. The method of 11 wherein at least one port is provided in the equine shoe which extends through all strata of the solid member, and a removable and replaceable plug is provided for the at least one port, and wherein the method further comprises:
(3) providing therapeutic compound to the equine hoof while wearing the shoe.
